(19) United States
(12) Patent Application Publication
(10) Pub. No.: US 2016/0117160 A1
(43) Pub. Date: Apr. 28, 2016

(54) PREPARING INSTALLATIONS AND UPDATES FOR SOFTWARE SYSTEMS

(71) Applicant: Microsoft Corporation, Redmond, WA (US)

(72) Inventors: Srivatsan Parthasarathy, Seattle, WA (US); Jeffrey Scott Zabel, Redmond, WA (US); Mohanish Rajesh Penta, Bellevue, WA (US); Kiran Isaac Abraham, Redmond, WA (US); Spencer James Clark, Redmond, WA (US); Haojie Hang, Bellevue, WA (US); Mokhtar M. Khorshid, Redmond, WA (US); Filippo Seracini, Bellevue, WA (US); Justin R. Incarnato, Fort Worth, TX (US)

(21) Appl. No.: 14/525,176

(22) Filed: Oct. 27, 2014

(51) Int. Cl. G06F 9/445; H04L 29/08

(52) U.S. Cl. CPC G06F 8/65; H04L 67/06

(57) ABSTRACT

The present invention extends to methods, systems, and computer program products for preparing installations and updates for software systems. Aspects of the invention include creating software update packages that are selectable to automatically install essentially any number of code changes for any number of software components to update a software system (e.g., a cloud appliance). In one aspect, a software update package includes: references to code changes for a plurality of software components and references to installation artifacts for installing the code changes, and also indicates interdependencies between the plurality of software components. In another aspect, a software update package includes references to validation code for validating that a software update package transitioned a software system to a goal state. In a further aspect, a software update package expressly indicates that installation artifact references for different installation artifacts are to be processed during different passes in a multi-pass installation process.

### CROSS-REFERENCE TO RELATED APPLICATIONS

Not Applicable

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

To perform computing tasks, computer systems run software. For example, to provide word processing functionality a computer system runs word processing software (an application). Software is continually evolving to include updated functionality, for example, to correct bugs, address security issues, add features, etc. From time to time, a software developer can release updates to their software that include updated functionality. Computer system users can install updates at their computer system to add updated functionality to their software.

In a standalone computing environment (e.g., on a home users desktop computer) installing updates is a relatively straight forward process. Many applications and operating systems have built in updaters (other software) that use network (e.g., Internet) connectivity to determine when an update is available. Some updaters automatically alert users (e.g., through a user-interface) when updates are available. Other updaters at least permit users to check for updates when they desire. When an update is available, the user can select the update and the updater automatically installs the update for the user.

In cloud computing environments, applications and operating systems are run in distributed and/or networked environments, such as, for example, in public and private clouds. Within a cloud computing environment, hardware can be configured as virtual machines (“VMs”). VMs can be allocated for different functions, such as, management, compute, storage, and networking. Management VMs can include a variety of different interoperating management software applications that provide management functionality to a client or customer. Management functionality can include configuring, deploying, monitoring, and updating of management VMs, compute VMs, storage VMs, and networking VMs.

Different development groups can own and have responsibly for maintaining different management software applications. As such, the timing of releasing updates for different management software applications can vary. Some development groups can release updates on a schedule and others can release updates on an ad hoc basis. Even when updates are released on a schedule, different development groups can have different schedules. Thus, at any given time, some different number and variety of management software application updates may be available for management VMs running in a cloud computing environment.

Updates in cloud computing environments, can also be performed manually. An administrator can identify a number of updates to install, manually formulate an installation plan (e.g., how to take down and bring up systems, determine a specified order for installing updates, etc.), and then install updates in accordance with the installation plan (e.g., take down and bring up systems, install updates in the specified order, etc.). However, since management software applications have to interoperate but are often developed by different groups, updates to one management software application can cause another management software application to operate in an unintended manner. Unintended operation can be caused by one development group not being aware of requirements for another development group's application, problems with an administrator's installation plan, etc.

In some cloud computing environments, software and hardware are owned by (or at least under control of) the same entity. For example, a software company may have a private cloud for employees. The private cloud can include various hardware components that run software, including various and different interpolating management software applications, developed by the software company. In these cloud computing environments, technicians and engineers have full access (both physically and virtually) to hardware and software. Having full access to hardware and software makes it somewhat easier for technicians and engineers to identify and address operational problems at management VMs.

In other cloud computing environments, software is developed by one entity and is run on hardware managed and controlled by a variety of other different entities. For example, a software company can develop management software for managing VMs in a cloud computing environment. The management software can include many different interoperating management software applications. A variety of other 3^{rd} parties (e.g., other companies) can purchase and run some or all of the different interoperating software applications to manage VMs run on hardware under their control. Some of 3^{rd} parties may use the management software to manage VMs in a private cloud used only by the company. Other of the 3^{rd} parties may use the management software to manage VMs that are resold to external customers. In some environments, a 3^{rd} party runs a complex, multi-node private cloud appliance, which delivers Infrastructure as a Service (“IaaS”) services to multiple tenants.

Updating management software applications in these other cloud computing environments is typically also performed manually by an administrator. However, identifying and addressing operational problems at management VMs can be much more difficult in these other cloud computing environments. For example, different 3^{rd} parties can have different combinations of management software applications installed on their hardware. Different 3^{rd} parties can also have different combinations of updates, and possibly also additional fixes installed (3^{rd} parties may desire to update at their own pace). Thus, even if 3^{rd} parties have the same management software applications installed, the management software applications can be at different updates and may have different fixes installed.

Based on the number of management software applications and the number of updates and applied fixes for each management software application, a very large number of different combinations are possible. Each different combination of management software applications and updates, and possibly also fixes, can result in different operational problems. The sheer number of combinations can make it more difficult for technicians and engineers of the software developer to identify and address management software operational problems at 3rd parties' management VMs. For example, it may be difficult to even identify a prior functioning state for the management VMs.

Further, a 3^{rd} party may limit access (physical and/or virtual) to their software, hardware, and operational data (e.g., logs). For example, a 3^{rd} pay may no network (e.g., Internet) connectivity. Limited access can be due to requirements of a 3^{rd} party or of the 3^{rd} party's customers. For example, if a healthcare provider is a customer of a 3^{rd} party cloud provider, the healthcare provider may limit those with access to patient healthcare data. Having limited access to one or more of: software, hardware, and data further increases difficulty for technicians and engineers when attempting to identify and address management software operational problems at 3rd parties' management VMs.

Additionally, 3^{rd} may require that updates be performed in a manner that does not violate designated Service Level Agreements (“SLAs”). There can be one SLA between a management software application provider and the 3^{rd} party. This SLA can specify the maximum downtime a management head can incur. There can be another SLA between the 3^{rd} party and its customers. This other SLA specifies the maximum downtime a customer will face for his assets, Thus, any updates, as well as any necessary troubleshooting, cannot take down a 3^{rd} party's management VMs for any significant amount of time without incurring costs under one or both SLAs. Installing software updates in a manner that does not violate customer SLAs increases installation complexity.

### BRIEF SUMMARY

The present invention extends to methods, systems, and computer program products for preparing installations and updates for software systems. Various different development groups manage the development of code for a plurality of corresponding (and possibly interoperating) software components (e.g., applications, operating system, etc.) of a software system (e.g., a cloud appliance). Each different development group can release code changes (e.g., updates and/or fixes) for their corresponding software component(s) at different and varied times.

Aspects of the invention include creating software update packages that can be selected to automatically install essentially any number of code changes for any number of software components to update a software system. In one aspect, a software update package includes: references to code changes for a plurality of software components and references to installation artifacts for installing the code changes, and also indicates interdependencies between the plurality of software components. In another aspect, a software update package includes references to validation code for validating that a software update package has transitioned a software system to a goal state. In a further aspect, a software update package expressly indicates that installation artifact references for different installation artifacts are to be processed during different passes in a multi-pass installation process for updating a software system.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific implementations thereof which are illustrated in the appended drawings. Understanding that these drawings depict only some implementations of the invention and are not therefore to be considered to be limiting of its scope, the invention will be described and explained with additional specificity and detail through the use of the accompanying drawings in which:

FIG. 1 illustrates an example computer architecture illustrating software changes being released by development groups.

FIG. 2 illustrates an example computer architecture that facilitates creating a software update package.

FIG. 3 illustrates a flow chart of an example method for creating a software update package.

FIG. 4 illustrates an example of a Bill of Materials (BOM) for a software update package.

FIG. 5 illustrates an example computer architecture that facilitates creating software installation packages and software update packages.

FIG. 6 illustrates an example of timing for different customers installing software updates.

FIG. 7 illustrates an example computer architecture that facilitates creating a software update package for linear progression between validated goal states.

FIG. 8 illustrates a flow chart of an example method for creating a software update package for linear progression between validated goal states.

FIG. 9 illustrates an example computer architecture that facilitates creating a software update package for use in a mutli-pass installation.

FIG. 10 illustrates a flow chart of an example method for creating a software update package for use in a multi-pass installation.

FIG. 11 illustrates an example computer architecture depicting a data flow for updating cloud appliances.

### DETAILED DESCRIPTION

The present invention extends to methods, systems, and computer program products for preparing installations and updates for software systems. Various different development groups manage the development of code for a plurality of corresponding (and possibly interoperating) software components (e.g., applications, operating system, etc.) of a software system (e.g., a cloud appliance). Each different development group can release code changes (e.g., updates and/or fixes) for their corresponding software component(s) at different and varied times.

Aspects of the invention include creating software update packages that can be selected to automatically install essentially any number of code changes for any number of software components to update a software system. In one aspect, a software update package includes: references to code changes for a plurality of software components and references to installation artifacts for installing the code changes, and also indicates interdependencies between the plurality of software components. In another aspect, a software update package includes references to validation code for validating that a software update package has transitioned a software system to a goal state. In a further aspect, a software update package expressly indicates that installation artifact references for different installation artifacts are to be processed during different passes in a multi-pass installation process for updating a software system.

Implementations of the present invention may comprise or utilize a special purpose or general-purpose computer including computer hardware, such as, for example, one or more processors and system memory, as discussed in greater detail below. Implementations within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, wearable devices, multi-processor systems, microprocessor-based or programmable consumer electronics, network PCs, minicomputers, mainframe computers, mobile telephones, PDAs, tablets, pagers, watches, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

In this description and the following claims, a “cloud appliance” is defined as a computer system (e.g., commodity hardware) running one or more (e.g., pre-configured) software components. In some aspects, a cloud appliance is a computer system with a virtual machine (VM) image installed. The virtual machine image file can include one or more (pre)configured software components.

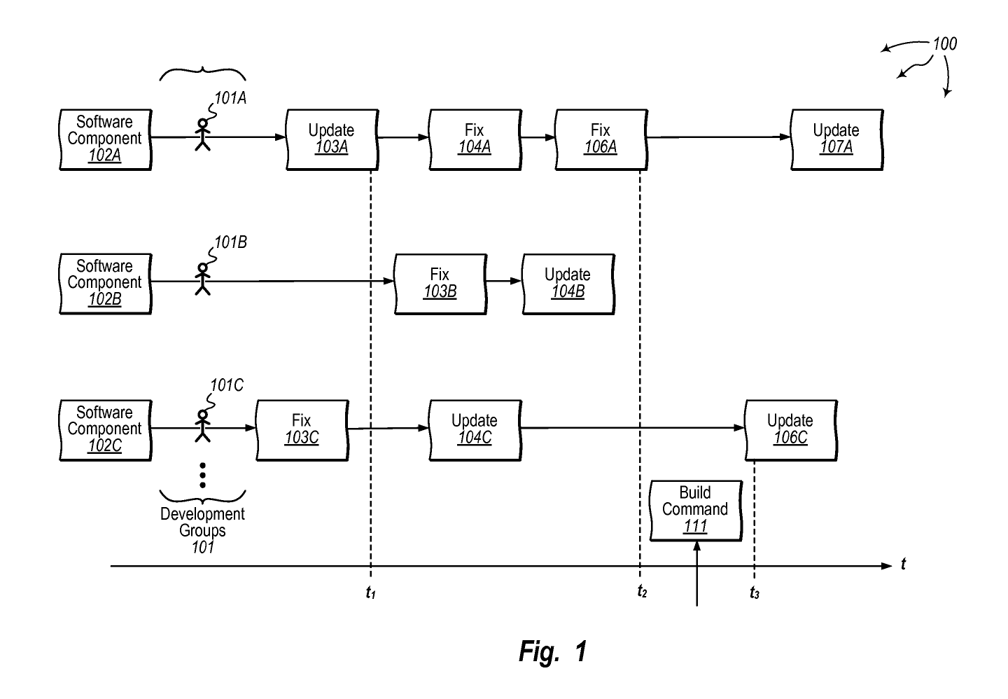

FIG. 1 illustrates an example computer architecture 100 illustrating software changes (e.g., updates and/or fixes) being released by development groups. As depicted, development groups 101 include development groups 101A, 101B, 101C, etc. Each of development groups 101A, 101B, 101C, etc. can be responsible for one or more of: developing, maintaining, and updating a software component that is run on software systems (e.g., cloud appliances). For example, development group 101A can be responsible for software component 102A, development group 101B can be responsible for software component 102B, development group 101C can be responsible for software component 102C, etc.

To maintain a software component, a development group can release changes to the software component. Different development groups can release changes to their software components at different and varied times.

In FIG. 1, time progresses from left (earlier in time) to right (later in time). Thus, over time, development group 101A releases various changes to software component 102A, including update 103A, followed by fix 104A, followed by fix 106A, followed by update 107A to. Similarly, over time, development group 101B releases various changes to software component 102B, including fix 103B, followed by update 104B. Likewise, over time, development group 101C releases various changes to software component 102C, including fix 103C, followed by update 104C, followed by update 106C.

As such, at any given time, a variety of different combinations of changes may be available for different software components. At time t₁, update 103A and fix 103C are available. Later at time t₂, update 103A, fix 104A, fix 106A, fix 103B, update 104B, fix 103C, and update 104C are available. As time progresses, other updates and/or fixes may become available.

At some time between t₂ and t₃, build command 111 can be issued. Build command 111 can be a manual or automated command to build a new software update package.

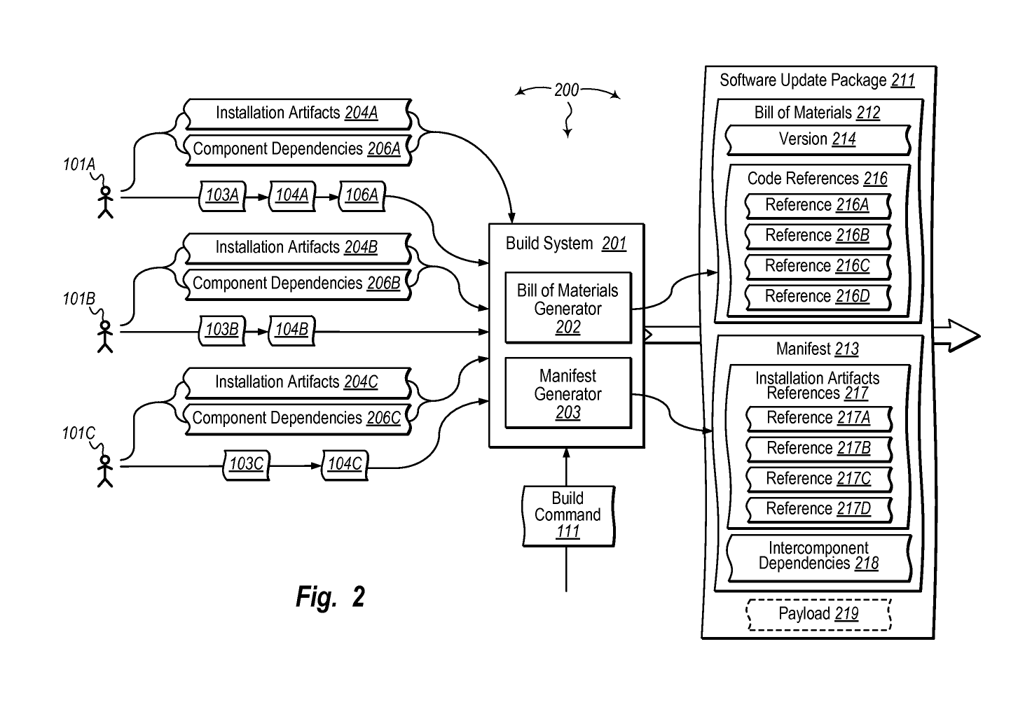

Turning to FIG. 2, FIG. 2 illustrates an example computer architecture 200 that facilitates creating a software installation package. Referring to FIG. 2, computer architecture 200 includes build system 201. Build system 201 can be connected to (or be part of) a network, such as, for example, a Local Area Network (“LAN”), a Wide Area Network (“WAN”), and even the Internet. Accordingly, build system 201 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

As depicted, build system 201 further includes bill of materials generator 202 and manifest generator 203. In general, Bill of materials generator 202 is configured to generate Bills of Material (BOM) for inclusion in a software update package. Similarly, manifest generator 203 is configured to generate a manifest for inclusion in a software update package.

Bill of materials generator 202 can generate a list of changes that are to be applied to take a software system (e.g., a cloud appliance) to a next version. To facilitate single-click upgrades, a Bill of Materials (BOM) is designed to be cumulative. During a build process, bill of materials generator 202 scans accessed changes (e.g., updates and fixes) to automatically generate a list of updates that are to be applied.

Along with code changes for a software component, a development group can also make installation artifacts (e.g., installation artifacts 204A, 204B, 204C) and component dependencies (e.g., component dependencies 206A, 206B, 206C) for the software component available to build system 201.

Manifest generator 203 can generate a manifest that includes a list of installation artifacts (e.g., installation scripts) used to install the listed updates in a BOM and that describes intercomponent dependencies between software components. During a build process, manifest generator 203 scans provided installation artifacts and component dependencies. Manifest generator 203 can use the provided installation artifacts to generate the list of installation artifacts for installing the listed updates. Manifest generator 203 can also analyze provided component dependencies to identify intercomponent dependencies.

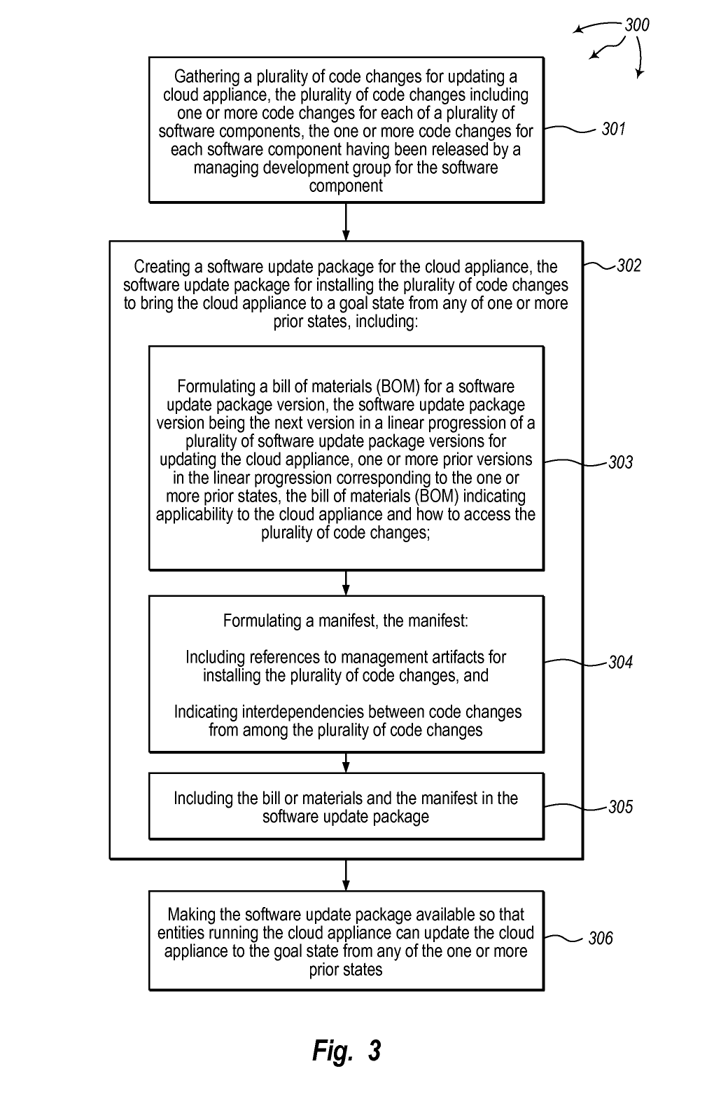

FIG. 3 illustrates a flow chart of an example method 300 for creating a software update package. Method 300 will be described with respect to the components and data of computer architecture 200.

Method 300 includes gathering a plurality of code changes for updating a cloud appliance, the plurality of code changes including one or more code changes for each of a plurality of software components, the one or more code changes for each software component having been released by a managing development group for the software component (301). For example, in response to build command 111, build system 201 can gather update 103A, fix 104A, fix 106A, fix 103B, update 104B, fix 103C, and update 104C for updating a cloud appliance that includes software components 102A, 102B, and 102C.

Method 300 includes creating a software update package for the cloud appliance, the software update package for installing the plurality of code changes to bring the cloud appliance to a goal state from any of one or more prior states (302). For example, build system 201 can create software update package 211. Software update package 211 can be used for installing update 103A, fix 104A, fix 106A, fix 103B, update 104B, fix 103C, and update 104C to bring a cloud appliance that includes software components 102A, 102B, and 102C to a goal state.

Creating a software package from the cloud appliance includes formulating a bill of materials (BOM) for a software update package version, the software update package version being the next version in a linear progression of a plurality of software update package versions for updating the cloud appliance, one or more prior versions in the linear progression corresponding to the one or more prior states, the bill of materials (BOM) indicating applicability to the cloud appliance and how to access the plurality of code changes (303). For example, bill of materials generator 202 can formulate bill of materials (BOM) 212. Bill of materials 212 includes version 214 and code references 216. Version 214 is the next version in a linear progression of software update package versions for updating a cloud appliance that includes software components 102A, 102B, and 102C. As such, build system 201 may have previously created other software update packages for updating a cloud appliance that includes software components 102A, 102B, and 102C. For example, build system 201 may have previously created a software update package based on update 103A and fix 103C shortly after t₁. When installed, this previous software update package would bring a cloud appliance that includes software components 102A, 102B, and 102C to one of the one or more prior states.

Bill of materials generator 202 can scan update 103A, fix 104A, fix 106A, fix 103B, update 104B, fix 103C, and update 104C to automatically generate code references 216. Code references 216 include references for accessing code changes. For example, reference 216A can correspond to a location for update 103A, reference 216B can correspond to a location for fix 104A, reference 216C can correspond to a location for fix 106A, reference 216D can correspond to a location for fix 103B, etc. In one aspect, when an express reference for a code change is not included, an installation system can be configured to check an external default location for the code change. In another aspect, when an express reference for a code change is not included, an installation system can check a payload attached to a software update package.

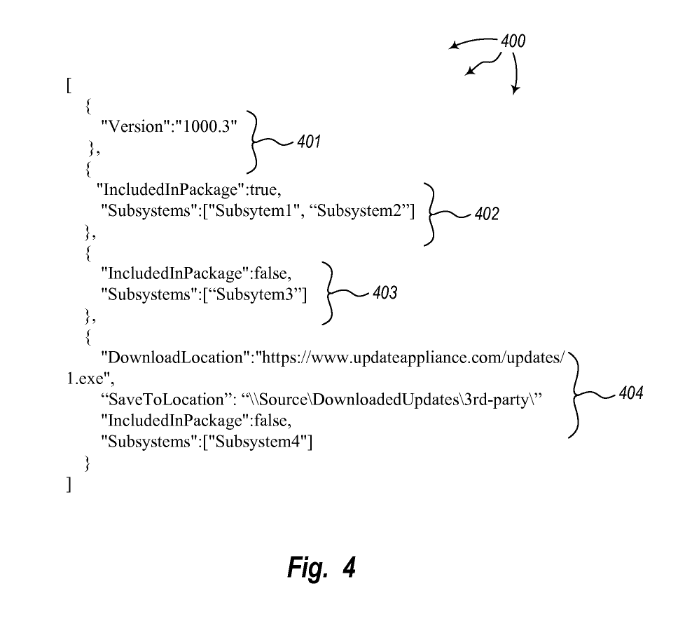

Turning briefly to FIG. 4, FIG. 4 illustrates an example of a Bill of Materials (BOM) 400 for a software update package. Within BOM 400, block 401 indicates a version for BOM 400. Block 402 indicates that code changes for “subsystem1” and “subsystem2” are included in the software update package containing BOM 400. Block 403 indicates that code changes for “subsystem3” are not included in the software update package containing BOM 400. Since no other express reference is indicated, an installation system can check an external default location (e.g., an update Web site) for code changes for subsystem3. Block 404 indicates that code changes for “subsystem4” are not in an attached payload. An express reference indicates that code changes for Subsystem4 can be downloaded from “https://www.updateappliance.com/updates/1.exe” and saved to “\\Source\DownloadedUpdates\3rd-party\”.

Returning back to FIG. 3, creating a software package from the cloud appliance includes formulating a manifest. The manifest incudes references to management artifacts for installing the plurality of code changes and indicates interdependencies between code changes from among the plurality of code changes (304). For example, manifest generator 203 can formulate manifest 213. Manifest 213 includes installation artifact references 217 and intercomponent dependencies 218. In general, management artifacts can include install scripts, runbooks, images, packages, management packs, validation packs, etc.

Manifest generator 213 can scan installation artifacts 204A, 204B, and 204C to generate installation artifact references 217. Each reference in installation artifact references 217 can refer to an installation artifact for a corresponding code change. For example, reference 217A can refer to an installation artifact for update 103A, reference 217B can refer to an installation artifact for fix 104A, reference 217C can refer to an installation artifact for fix 106A, reference 217D can refer to an installation artifact for fix 103B, etc.

Manifest generator 213 can also analyze component dependencies 206A, 206B, and 206C to determine intercomponent dependencies 218. Intercomponent dependencies 218 can describe dependencies between software components 102A, 102B, and 102C.

Creating a software package from the cloud appliance includes including the bill or materials and the manifest in the software update package (305). For example, build system 201 can include bill of materials (BOM) 212 and manifest 213 in software update package 211.

When appropriate, build system 201 can also include payload 219 in software update package 212. Payload 219 can include code changes, such as, for example, one or more of: 103A, fix 104A, fix 106A, fix 103B, update 104B, fix 103C, and update 104C.

Method 300 includes making the software update package available so that entities running the cloud appliance can update the cloud appliance to the goal state from any of the one or more prior states (306). For example, build system 201 can store software update package 211 in a known location for software updates. A known location can include, for example, a zip driver, an update server, an update directory, an update website, a movable disk, etc.

In one aspect, a build system generates a corresponding software installation package along with a software update package in response to a build command. The software installation package can be used to install instances of cloud appliance on hardware. The software update package can be used update instances of cloud appliance that are already installed on hardware. Both the software installation package and the software update package are configured to bring a cloud appliance to the essentially same goal state.

In another aspect, intermediate staging servers and/or build servers can be used to stage code changes or build an update/fix for an individual software component. Code can be staged and updates/fixes built for individual software components between more complex installation/update builds for a cloud appliance.

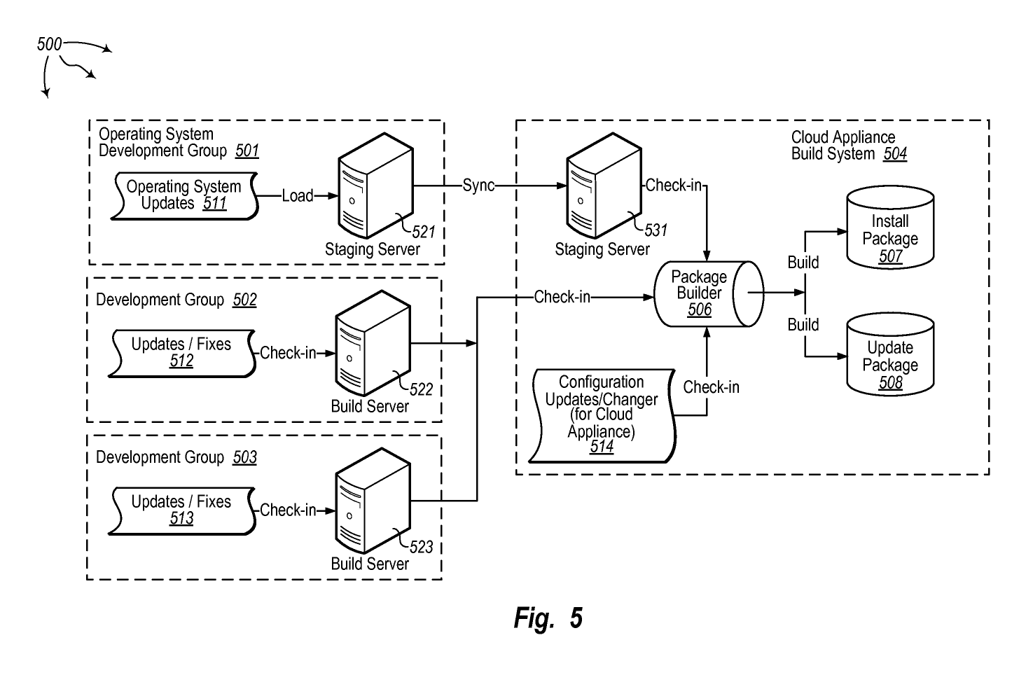

FIG. 5 illustrates an example computer architecture 500 that facilitates creating software installation packages and software update packages. As depicted, operating system development group 501, development group 502, and development group 503 can submit updates/fixes to cloud appliance build system 504. Operating system updates 511 can be loaded to staging server 521. Updates/fixes 512 can be checked-in to build server 522. Update/fixes 513 can be checked-in to build server 523.

Operating system updates 511 can be synced to staging server 531. From staging server 531, operating system updates 511 can be checked-in with package builder 506. Similarly, updates/fixes 512 and update/fixes 513 can be checked-in with package builder 506 from build servers 522 and 523 respectively. Configuration updates/changes 514 (for a cloud appliance) can also be checked-in with package builder 506. In response to a build command, package builder 506 can build install package 507 and update package 505 for a cloud appliance based on operating system updates 511, updates/fixes 512, update/fixes 513, and configuration updates/changes 514.

In general, a build system can release software update versions in a linear progression and can track the goal state of each software update version. A build system can also consider cumulative impacts of code changes to software components spanning across software update versions. When creating a software update version in the linear progression, the build system can determine how to get a cloud appliance from the goal state of any prior software update versions to the goal state of the software update version being built.

As such, each of installation package 507 and update package 508 are configured to bring a cloud appliance to the same goal state. Additionally, update package 508 can be configured to bring a cloud appliance to the same goal state independent of the prior state of the cloud appliance.

For example, a first instance of a cloud appliance may be at a prior state achieved from installing an update package two or more versions prior to update package 508. A second instance of the cloud appliance may be at a different prior state achieved from installing a version of an update package immediately prior to update package 508. Installing update package 508 on either of the first or second instance of the cloud appliance would cause a transition to the goal state for update package 508. As such, customers have increased flexibility to choose when to apply updates.

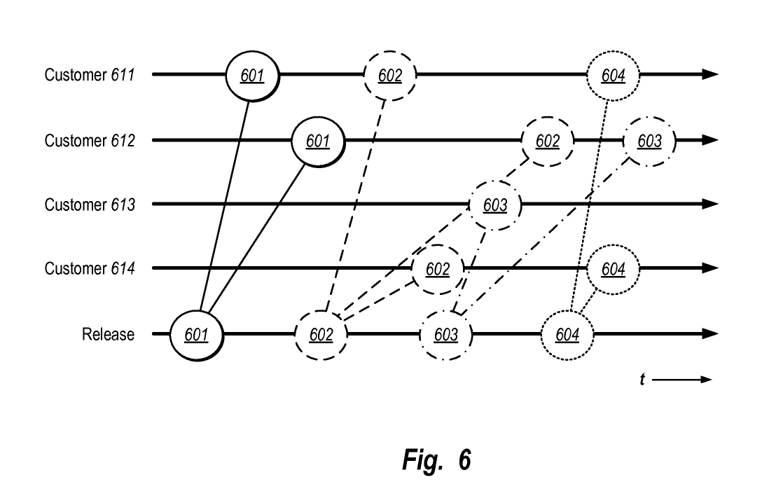

FIG. 6 illustrates an example of timing for different customers installing software updates. In FIG. 6, time progresses from left (earlier in time) to right (later in time). Version 601 is released before version 602. Version 602 is released before version 603. Version 603 is release before version 604. However, as depicted, each customer chooses to update at a different pace and even skip versions.

As depicted, customers 611 and 612 install version 601. Customer 611 updates from version 601 to version 602 prior to the release of version 603. On the other, customer 612 updates from version 601 to version 602 after the release of version 603.

Customer 614 installs version 602. Customer 614 updates from version 602 to version 604 skipping version 603. Similarly, customer 611 updates from version 602 to version 604 skipping version 603. Customer 613 installs version 603 and does not update to version 604. Customer 612 updates from version 602 to version 603 after version 604 is released.

A software update package can refer to and/or include validation code for validating a change to one or more software components. In one aspect, validation code for validating a code change (e.g., update or fix) to a software component is included in installation artifacts (e.g., in installation artifacts 204A, 204B, 204C, etc.) for the software component. In another aspect, validation code for validating a code change to a software component is separate from installation artifacts for the software component. Validation code for a software component may or may not be maintained by the development group that maintains the software component. After a code change for a software component is implemented, the validation code can be run to validate that the code change was properly implemented.

Similar validation code can be used to validate an initial installation of a software component. After software component is installed, validation code can be run to validate that the installation was properly implemented.

A build system can also formulate additional validation code for validating that the contents of a software update package or a software installation package brought a cloud appliance to an indicated goal state. After installation of and/or code changes for individual software components are validated, the additional validation code can be run to validate that the cloud appliance was brought to a goal state. In one aspect, the additional validation code is used to validate intercomponent dependencies identified through build system analysis (and possibly not otherwise indicated by development groups).

As such, software update packages can progress through a linear progression of validated states. Since prior states are validated and a build system can track prior states, the number of different combinations and versions of software components possibly used for a cloud appliance is significantly reduced. The reduced number of states in turn reduces the complexity of progressing from a prior state to a goal state (even when software update packages corresponding to one or more intermediate states in the linear progression are not used). The reduced number of states also reduces test burden.

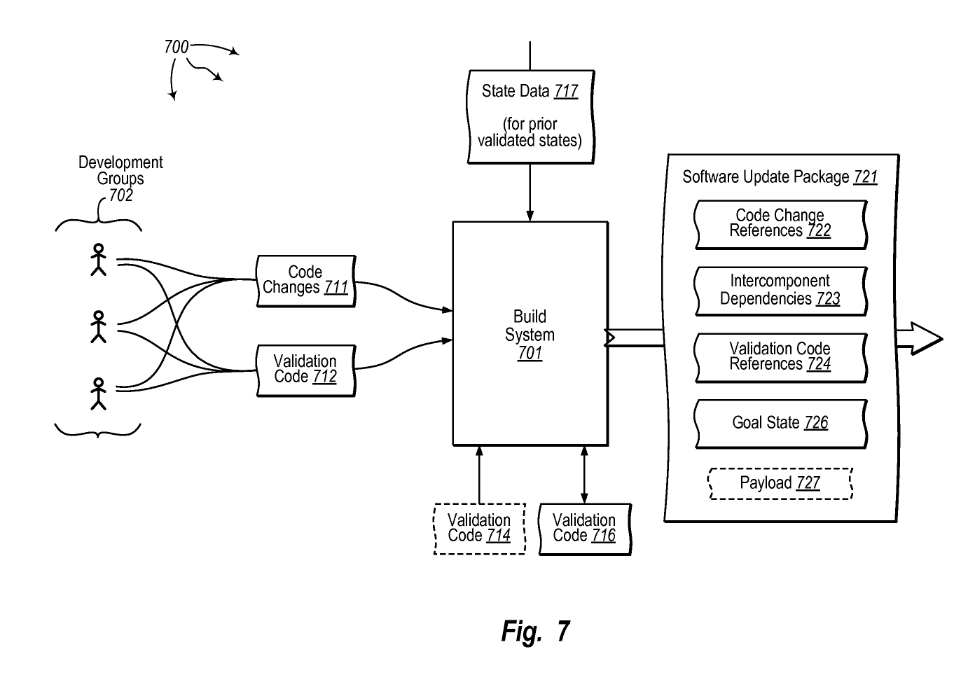

Turning to FIG. 7, FIG. 7 illustrates an example computer architecture 700 that facilitates creating a software update package for linear progression between validated goal states. Referring to FIG. 7, computer architecture 700 includes build system 701. Build system 701 can be connected to (or be part of) a network, such as, for example, a Local Area Network (“LAN”), a Wide Area Network (“WAN”), and even the Internet. Accordingly, build system 701 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, build system 701 can build a software update package for validating progression of a cloud appliance to a goal state. Build system 701 is configured to access code changes (e.g., updates and/or fixes) from development groups for software components used in a cloud appliance. Build system 701 is also configured to access validation code for validating proper implementation of accessed code changes. Build system 701 is also configured to access state data for one or more prior validated states for the cloud appliance. The cloud service linearly can have progressed through the one or more prior validated states by implementing previously built software update packages to update the cloud appliance. From the accessed code changes, the accessed validation code, and the accessed state data, build system 701 can build a software update package for validating linear progression of the software appliance from any of the one or more prior validated states to the goal state.

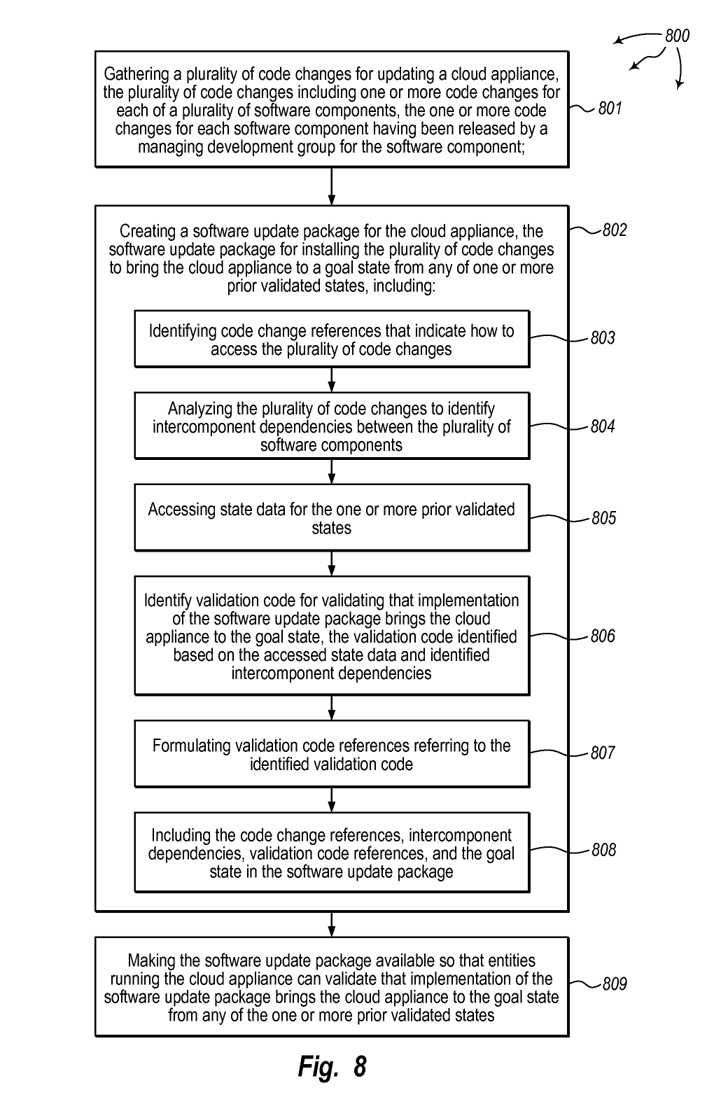

FIG. 8 illustrates a flow chart of an example method for 800 creating a software update package for linear progression between validated goal states. Method 800 will be described with respect to the components and data of computer architecture 700.

Method 800 includes gathering a plurality of code changes for updating a cloud appliance, the plurality of code changes including one or more code changes for each of a plurality of software components, the one or more code changes for each software component having been released by a managing development group for the software component (801). For example, build system 701 can gather code changes 711 from development groups 702. Each of development groups 702 can manage a software component to be updated at a cloud appliance.

Method 800 includes creating a software update package for the cloud appliance, the software update package for installing the plurality of code changes to bring the cloud appliance to a goal state from any of one or more prior validated states (802). For example, build system 701 can build software update package 721. Software update package 721 can be for implementing code changes 711 at a cloud appliance to bring the cloud appliance to goal state 726 from any of one or more prior validated states.

Creating a software update package for the cloud appliance includes identifying code change references that indicate how to access the plurality of code changes (803). For example, build system 701 can identify code change references that indicate how to access code changes 711. Creating a software update package for the cloud appliance includes analyzing the plurality of code changes to identify intercomponent dependencies between the plurality of software components (804). For example, build system 701 can analyze code changes 711 (possible along with other developer provider information) to identify intercomponent dependencies 723 between software components managed by development groups 702.

Creating a software update package for the cloud appliance includes accessing state data for the one or more prior validated states (805). For example, build system 701 can access state data 717. State data 717 can be for one or more prior validated states of the cloud appliance.

Creating a software update package for the cloud appliance includes identify validation code for validating that implementation of the software update package brings the cloud appliance to the goal state, the validation code identified based on the accessed state data and identified intercomponent dependencies (806). For example, build system 701 can identify relevant portions of one or more of: validation code 717 (provided by development groups 702) and validation code 714 (provided from other sources) based on state data 717 and intercomponent dependencies 723. Identified portions of validation code can be used to validate that software update package 721 brings a cloud appliance to goal state 726.

Build system 701 can also manage validation code 716. When build system 701 detects that other validation code is insufficient for validating a software update package, build system 701 can create or modify validation code 716 to supplement the other validation code.

Creating a software update package for the cloud appliance includes formulating validation code references referring to the identified validation code (807). For example, build system 701 can formulate validation code references 724 referring to identified portions of one or more of: validation code 712, validation code 714, and validation code 716.

Creating a software update package for the cloud appliance includes including the code change references, intercomponent dependencies, validation code references, and the goal state in the software update package (808). For example, build system 701 can include code change references 732, intercomponent dependencies 723, validation code references 724, and goal state 726 in software update package 731. When appropriate, build system 701 can also include payload 727 in software update package 721. Payload 727 can contain code changes and/or validation code.

Method 800 includes making the software update package available so that entities running the cloud appliance can validate that implementation of the software update package brings the cloud appliance to the goal state from any of the one or more prior validated states (809). For example, build system 701 can store software update package 721 in a known location for software updates. A known location can include, for example, an update directory, an update website, a movable disk, etc.

Methods similar to method 800 can also be used to create a software installation package.

In some aspects, software update packages are created for use in a multi-pass installation process. Each pass of the multi-pass process can perform a portion of the work for installing a software update and validating the software update. Installation artifacts for each software component can have code tailored to different passes in a multi-pass installation process. The tailored code can specify actions to be executed for each pass in the multi-pass process. In one aspect, passes in a multi-pass process including a pre-validation pass, an update pass, and a test pass.

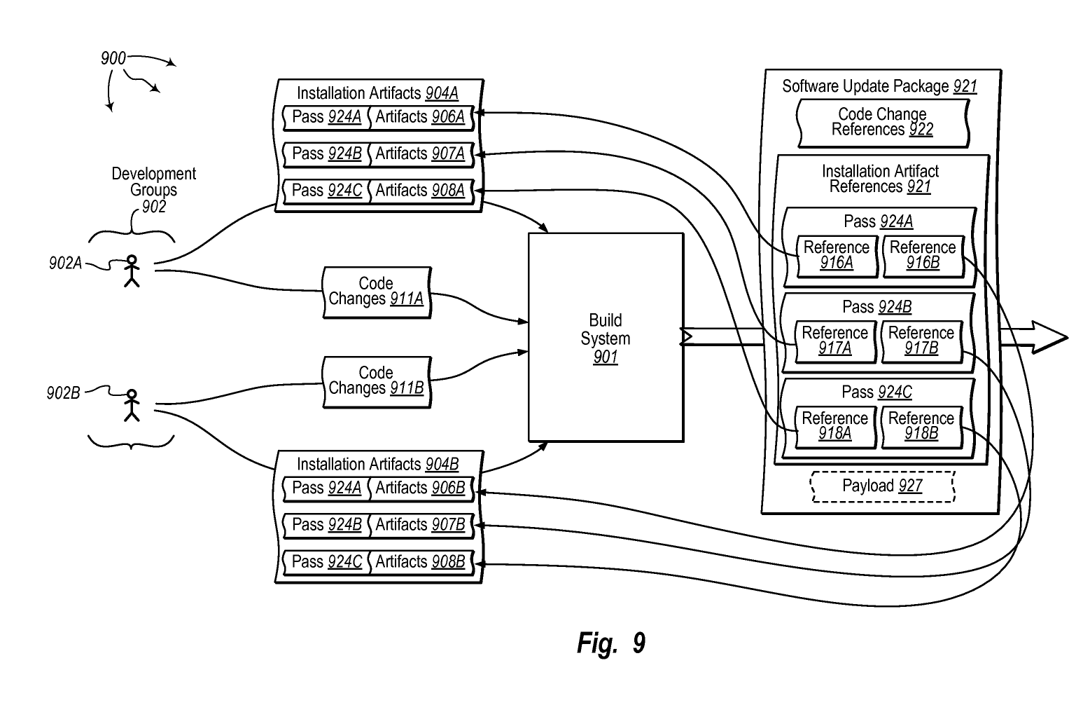

Turning to FIG. 9, FIG. 9 illustrates an example computer architecture 900 that facilitates creating a software update package for use in a mutli-pass installation. Referring to FIG. 9, computer architecture 900 includes build system 901. Build system 901 can be connected to (or be part of) a network, such as, for example, a Local Area Network (“LAN”), a Wide Area Network (“WAN”), and even the Internet. Accordingly, build system 901 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, build system 901 can build a software update package for use in a multi-pass installation. Build system 901 is configured to access code changes (e.g., updates and/or fixes) from development groups for software components used in a cloud appliance. Build system 901 is also configured to access installation artifacts for installing accessed code changes. Build system 901 can identify installation artifacts tailored to a specified pass in the multi-pass installation. Build system 901 can group installation artifact references tailored for a specified pass together in a software update. From the accessed code changes and access installation artifacts, build system 901 can build a software update package for use in a multi-pass installation.

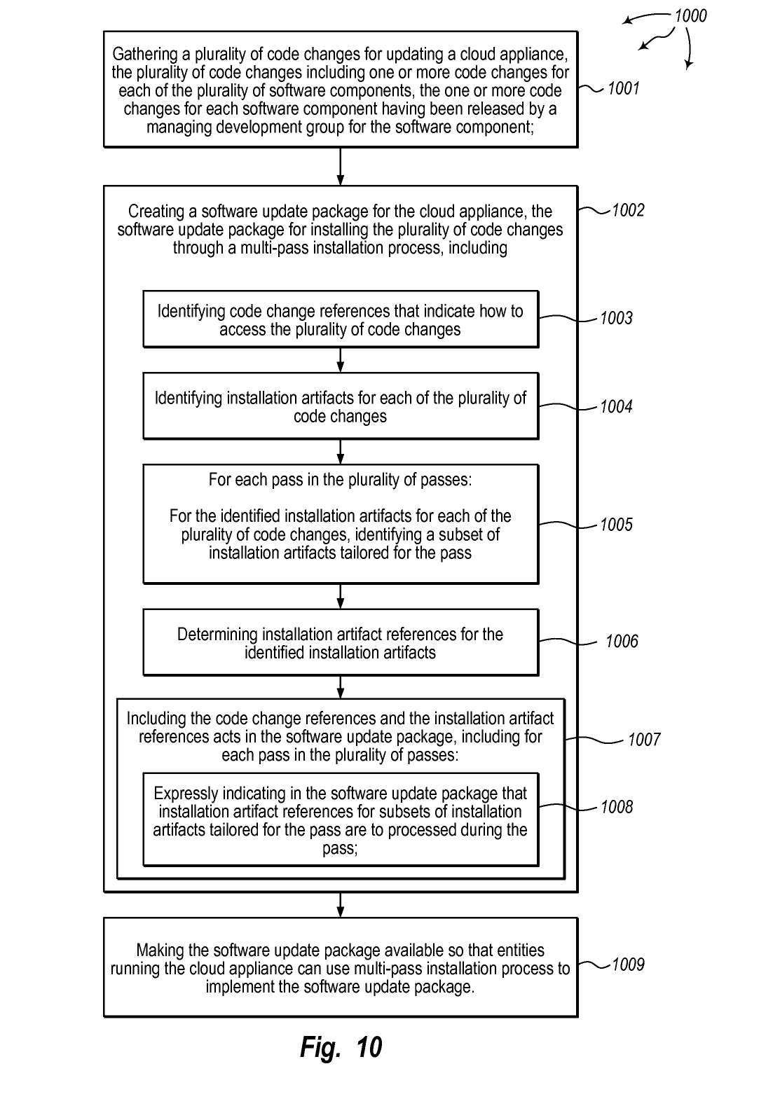

FIG. 10 illustrates a flow chart of an example method 1000 for creating a software update package for use in a multi-pass installation. Method 1000 will be described with respect to the components and data of computer architecture 900.

Method 1000 includes gathering a plurality of code changes for updating a cloud appliance, the plurality of code changes including one or more code changes for each of the plurality of software components, the one or more code changes for each software component having been released by a managing development group for the software component (1001). For example, build system 901 can gather code changes 911A and code changes 911B form development groups 902A and 902B respectively. Each of development groups 902A and 902B can manage a software component to be updated at a cloud appliance.

Method 1000 includes creating a software update package for the cloud appliance, the software update package for installing the plurality of code changes through the multi-pass installation process (1002). For example, build system 901 can create software update package 921 for the cloud appliance. Software update package 921 can be for implementing code changes 911A and 911B at the cloud appliance through a multi-pass installation process. The multi-pass installation process can include three passes, pass 924A (e.g., pre-validation), pass 924B (e.g., update), and pass 924C (e.g., testing).

Creating a software package includes identifying code change references that indicate how to access the plurality of code changes (1003). For example, build system 901 can identify code change references 922 that indicate how to access code changes 911A and 911B. Creating a software package includes identifying installation artifacts for each of the plurality of code changes (1004). For example, build system 901 can identify installation artifacts 904A and 904B for code changes 911A and 911B respectively.

Creating a software package includes, for each pass in the plurality of passes and for the identified installation artifacts for each of the plurality of code changes, identifying a subset of installation artifacts tailored for the pass (1005). For example, build system 901 can identify artifacts 906A and 906B tailored to pass 924A. Similarly, build system 901 can identify artifacts 907A and 907B tailored to pass 924B. Likewise, build system 901 can identify artifacts 908A and 908B tailored to pass 924C.

Creating a software package includes determining installation artifact references for the identified installation artifacts (1006). For example, build system 901 can identify installation artifact references 924 for installation artifacts 904A and 904B. More specifically, build system 901 can identity reference 916A for artifacts 906A, can identify identity reference 917A for artifacts 907A, can identity reference 918A for artifacts 908A, 901 can identity reference 916B for artifacts 906B, can identify identity reference 917B for artifacts 907B, and can identity reference 918B for artifacts 908B.

Creating a software package includes including the code change references and the installation artifact references in the software update package (1007). For example, build system 901 can include code change references and installation artifact references in software update package 921. When appropriate, build system 901 can also include payload 927 in software update package 921. Payload 927 can contain code changes and/or installation artifacts.

Including installation artifact references in the software update package includes for each pass in the plurality of passes, expressly indicating in the software update package that installation artifact references for subsets of installation artifacts tailored for the pass are to processed during the pass (1008). For example, build system 901 can indicate that references 916A and 916B are to be processed during pass 924A. Similarly, build system 901 can indicate that references 917A and 917B are to be processed during pass 924B. Likewise, build system 901 can indicate that references 918A and 918B are to be processed during pass 924C.

Method 1000 includes making the software update package available so that entities running the cloud appliance can use multi-pass installation process to implement the software update package (1009). For example, build system 901 can store software update package 921 in a known location for software updates. A known location can include, for example, an update directory, an update website, a movable disk, etc.

Methods similar to method 1000 can also be used to create a software installation package.

Any of the described aspects of the invention can also work in combination to create a software update package or software installation package. For example, a build system can create a software update package including a version, a bill of materials (BOM), and a manifest, wherein validation code references are included in the manifest. Alternately, a build system can build a software update package including a version, a bill or materials (BOM), and a manifest, wherein installation artifact references contained in a manifest are expressly assigned to different passes in a multi-pass installation process. As another option, a build system can build a software update package including validation code references, wherein the validation code references are expressly assigned to a pass of a multi-pass installation process.

In some environments, a plurality of development groups is changing code for a plurality at different software components included in a cloud appliance. Each development group can change code at a different pace. Aspects of the invention significantly reduce the complexity of updating instances of the cloud appliance with code changes and the potential for code divergence between different instances of a cloud appliance. In one aspect, a single click update is made available to entities running instances of the cloud appliance. The entities can select the update to automatically have a plurality of code changes to a plurality of different software components installed to update the cloud appliance.

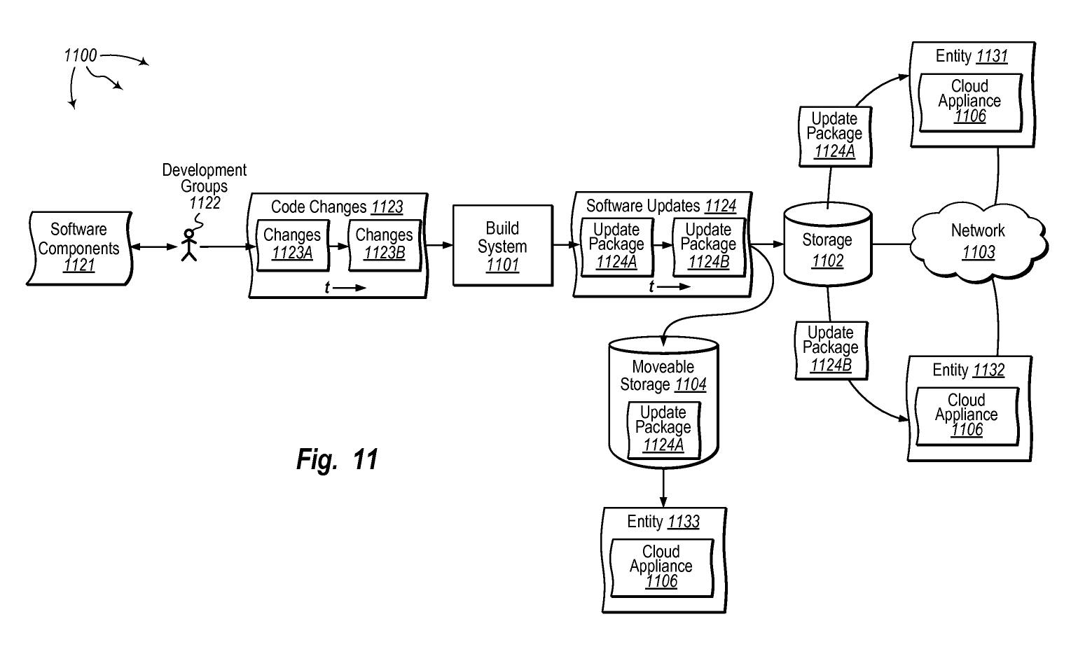

FIG. 11 illustrates an example computer architecture 1100 depicting a data flow for updating cloud appliances. Within computer architecture 1100, instances of cloud appliance 1106 can include software components 1121. Development groups 1122 can release code changes 1123 (e.g., code changes 1123A, 1123B, etc.) for software components 1121 over time. From time to time, for example, on a schedule or in response to an entity request, build system 1101 can build software updates 1124 (e.g., updates 1124A, 1124B, etc.). Build system 1101 can store software updates at storage 1102. Entities can access updates stored at storage 102 via network 1103 (e.g., the Internet). For example, entity 1131 can access update 1124A from storage 1102 to update cloud appliance 1106 (to one state). Similarly, entity 1132 can access update 1124B from storage 1102 to update cloud appliance 1106 (to another later state).

Entity 1133, for security and/or privacy reasons, may prefer to keep deployed cloud appliances disconnected from public networks (e.g., the Internet). As such, build system 1101 can also store any of software updates 1124, for example, update 1124A, into a self-contained package on movable storage 1104 (e.g., a thumb drive, DVD, CD, etc.) Movable storage 1104 can be provided to the entity 1133. Entity 1133 can use the self-contained package to update cloud appliance 110 without having to connect to a public network.

Build system 1101 can include any of the functionality described for build system 201, package builder 506, build system 701, and build system 901. Thus, build system 1101 can create software installation packages and software update packages. Build system 1011 can be configured to create packages including a bill of materials (BOM) and manifest (e.g., similar to software update package 211). Build system 1101 can also be configured create packages including validation code references (e.g., similar to software update package 721). Build system 1101 can further be configured to create packages with installation artifact references expressly assigned to different passes in a multi-pass installation process (e.g., similar to software update package 921). Build system 1101 can also be configured to create packages that contain different combinations of the described arrangements.

The present invention may be implemented in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for generating a software update package for updating a cloud appliance, the cloud appliance running a plurality of different software components, at least some of the plurality of software components interoperating with one another, each of the plurality of software components maintained by a different corresponding development group, the method comprising:
gathering a plurality of code changes for updating the cloud appliance, the plurality of code changes including one or more code changes for each of the plurality of software components, the one or more code changes for each software component having been released by a managing development group for the software component;
creating a software update package for the cloud appliance, the software update package for installing the plurality of code changes to bring the cloud appliance to a goal state from any of one or more prior states, including:
formulating a bill of materials (BOM) for a software update package version, the software update package version being the next version in a linear progression of a plurality of software update package versions for updating the cloud appliance, one or more prior versions in the linear progression corresponding to the one or more prior states, the bill of materials (BOM) indicating applicability to the cloud appliance and how to access the plurality of code changes;
formulating a manifest, the manifest:
including references to management artifacts for installing the plurality of code changes; and
indicating interdependencies between code changes from among the plurality of code changes; and
including the bill or materials and the manifest in the software update package; and
making the software update package available so that entities running the cloud appliance can update the cloud appliance to the goal state from any of the one or more prior states.

2. The method of claim 1, wherein manifest further comprises references to validation code for validating that a cloud appliance reached the goal state.

3. The method of claim 1, wherein the bill of materials (BOM) incudes code references to the plurality of code changes.

4. The method of claim 3, wherein the code references include a reference to a location on the Internet.

5. The method of claim 1, further comprising:
forming a payload that includes one or more management artifacts; and
including the payload in the software update package; and
wherein including references to management artifacts for installing the plurality of code changes comprises include a reference to the payload.

6. The method of claim 1, wherein making the software update package available comprises storing the software update package at a network location accessible to the entities running the cloud appliance.

7. The method of claim 1, wherein making the software update package available comprises storing the software update package to moveable drive that can be given to an entity running the cloud appliance.

8. The method of claim 1, wherein the manifest including references to management artifacts for installing the plurality of code changes comprises the manifest including references to management artifacts targeted to a specified pass in a multi-pass installation process.

9. A method for generating a software update package for updating a cloud appliance, the cloud appliance running a plurality of different software components, at least some of the plurality of software components interoperating with one another, each of the plurality of software components maintained by a different corresponding development group, the method comprising:
gathering a plurality of code changes for updating the cloud appliance, the plurality of code changes including one or more code changes for each of the plurality of software components, the one or more code changes for each software component having been released by a managing development group for the software component;
creating a software update package for the cloud appliance, the software update package for installing the plurality of code changes to bring the cloud appliance to a goal state from any of one or more prior validated states, including:
identifying code change references that indicate how to access the plurality of code changes;
analyzing the plurality of code changes to identify intercomponent dependencies between the plurality of software components;
accessing state data for the one or more prior validated states;
identifying validation code for validating that implementation of the software update package brings the cloud appliance to the goal state, the validation code identified based on the accessed state data and identified intercomponent dependencies;
formulating validation code references referring to the identified validation code; and
including the code change references, intercomponent dependencies, validation code references, and the goal state in the software update package; and
making the software update package available so that entities running the cloud appliance can validate that implementation of the software update package brings the cloud appliance to the goal state from any of the one or more prior validated states.

10. The method of claim 9, wherein identifying validation code for validating that implementation of the software update package brings the cloud appliance to the goal state comprises identifying validation code provided by a development group for one of the plurality of software components.

11. The method of claim 9, wherein identifying validation code for validating that implementation of the software update package brings the cloud appliance to the goal state comprises identifying validation code provided by a third party that is not a development group for any of the plurality of software components.

12. The method of claim 9, wherein identifying validation code for validating that implementation of the software update package brings the cloud appliance to the goal state comprises creating validation code for validating that implementation of the software update package brings the cloud appliance to the goal state.

13. The method of claim 9, further comprising:
forming a payload that includes identified validation code; and
including the payload in the software update package; and
wherein formulating validation code references referring to the identified validation code comprises formulating validation code references referring to the payload.

14. The method of claim 9, wherein accessing state data for the one or more prior validated states comprises access state data for one or more prior validated states in a linear progression of validated states, the goal state being the next state in the linear progression.

15. The method of claim 1, wherein formulating validation code references referring to the identified validation code comprises formulating validation code references to management artifacts targeted to a specified pass in a multi-pass installation process.

16. A method for generating a software update package for updating a cloud appliance through a multi-pass installation process having a plurality of passes, the cloud appliance running a plurality of different software components, each of the plurality of software components maintained by a different corresponding development group, the method comprising:
gathering a plurality of code changes for updating the cloud appliance, the plurality of code changes including one or more code changes for each of the plurality of software components, the one or more code changes for each software component having been released by a managing development group for the software component;
creating a software update package for the cloud appliance, the software update package for installing the plurality of code changes through the multi-pass installation process, including
identifying code change references that indicate how to access the plurality of code changes;
identifying installation artifacts for each of the plurality of code changes;
for each pass in the plurality of passes:
for the identified installation artifacts for each of the plurality of code changes, identifying a subset of installation artifacts tailored for the pass;
determining installation artifact references for the identified installation artifacts;
including the code change references and the installation artifact references in the software update package, including for each pass in the plurality of passes:
expressly indicating in the software update package that installation artifact references for subsets of installation artifacts tailored for the pass are to processed during the pass;
making the software update package available so that entities running the cloud appliance can use multi-pass installation process to implement the software update package.

17. The method of claim 16, wherein including the code change references and the installation artifact references in the software update package comprises including the installation artifact references in a manifest.

18. The method of claim 16, further comprising:
identify validation code for validating that implementation of the software update package brings the cloud appliance to the goal state, the validation code identified based on the accessed state data and identified intercomponent dependencies; and
formulating validation code references referring to the identified validation code.

19. The method of claim 17, further comprising expressly indicating that the validation code references are to be processed during a specific pass form among the plurality of passes.

20. The method of claim 19, further comprising:
forming a payload that includes the identified validation code; and
including the payload in the software update package; and
wherein formulating validation code references referring to the identified validation code comprises formulating validation code references referring to the payload.
